(19) United States
(12) Patent Application Publication
(10) Pub. No.: US 2012/0247343 A1
(43) Pub. Date: Oct. 4, 2012

(54) ROTARY ROASTER

(75) Inventor: Kuei-Tang CHANG, New Taipei City (TW)

(73) Assignee: Tall & Stout Industrial Corp.

(21) Appl. No.: 13/074,076

(22) Filed: Mar. 29, 2011

(51) Int. Cl. A47J 37/04

(52) U.S. Cl. 99/348; 99/443 R

(57) ABSTRACT

The rotary roaster includes a housing, a pot and a driving mechanism. The housing has a base. The driving mechanism is disposed on the base and has a rotary tray for being placed by the pot so that the pot is rotated by the rotary tray.

### BACKGROUND OF THE INVENTION

1. Technical Field

The invention relates to cooking heaters, particularly to roasters.

2. Related Art

Cooking with roasters requires less oil, generates less oily fumes and unmakes food organization less. Thus roasted food contains more juice and maintains good taste. A roaster is one of necessary kitchenware.

A conventional roaster is provided with a rotary stirrer in the pot and blows hot air onto the food in the pot with a heater. Hence the food can be evenly heated by the hot air and stirs.

However, the food tends to be rent or become soupy because of being continuously stirred by the stirrer. Further, piecemeal food in the roaster is hard to be evenly and completely stirred. And food in the roaster cannot be directly viewed because it is cloaked.

### SUMMARY OF THE INVENTION

An object of the invention is to provide a rotary roaster, which can make food evenly and completely stirred and heated.

To accomplish the above object, the rotary roaster of the invention includes a housing, a pot and a driving mechanism. The housing has a base. The driving mechanism is disposed on the base and has a rotary tray for being placed by the pot so that the pot is rotated by the rotary tray.

An advantage of the invention is structural simplification and stabilization by means of mounting the driving mechanism downwards. And the pot is made of transparent material and is partially exposed, so the food in the pot can be easily viewed by a user.

### BRIEF DESCRIPTION OF THE DRAWINGS

FIG. 1 is a cross-sectional view of the invention;

FIG. 2 is a partially enlarged view of region A in FIG. 1;

FIG. 3 is a top plan view of the pot, stirrer and driving mechanism;

FIG. 4 is a disassembled cross-sectional view of FIG. 3;

FIG. 5 is a cross-sectional view of the second embodiment of the invention;

FIG. 6 is a partially enlarged view of region B in FIG. 5; and

FIG. 7 is a disassembled cross-sectional view of the pot, stirrer and driving mechanism.

### DETAILED DESCRIPTION OF THE INVENTION

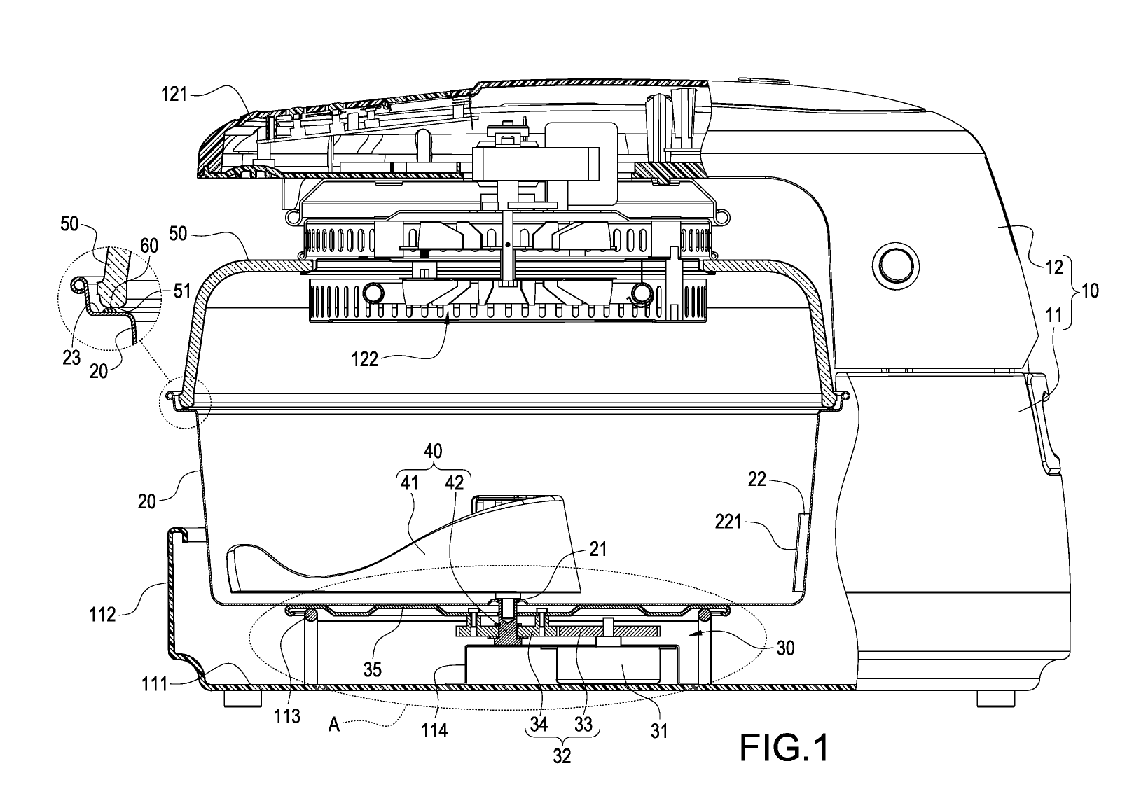

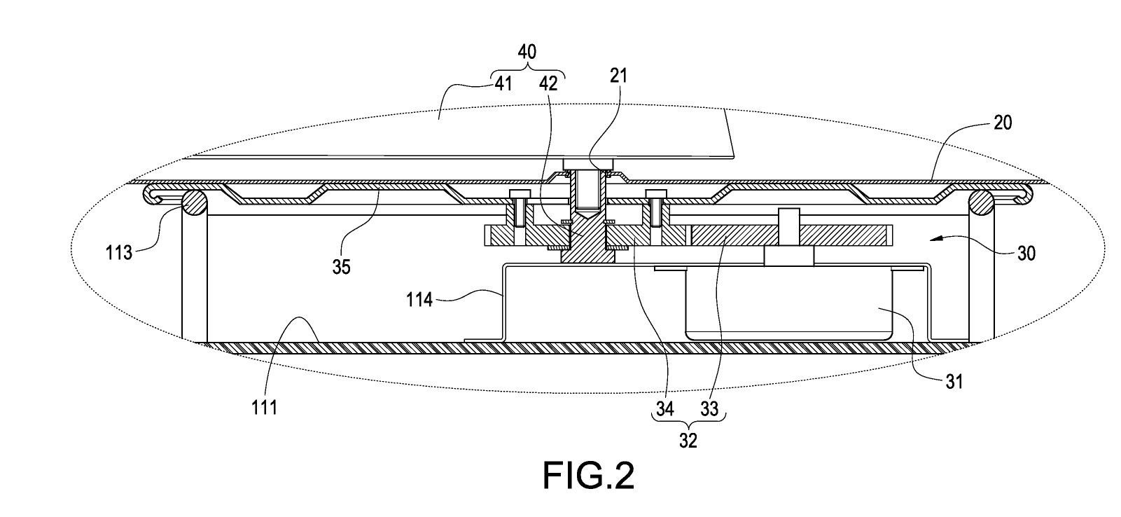

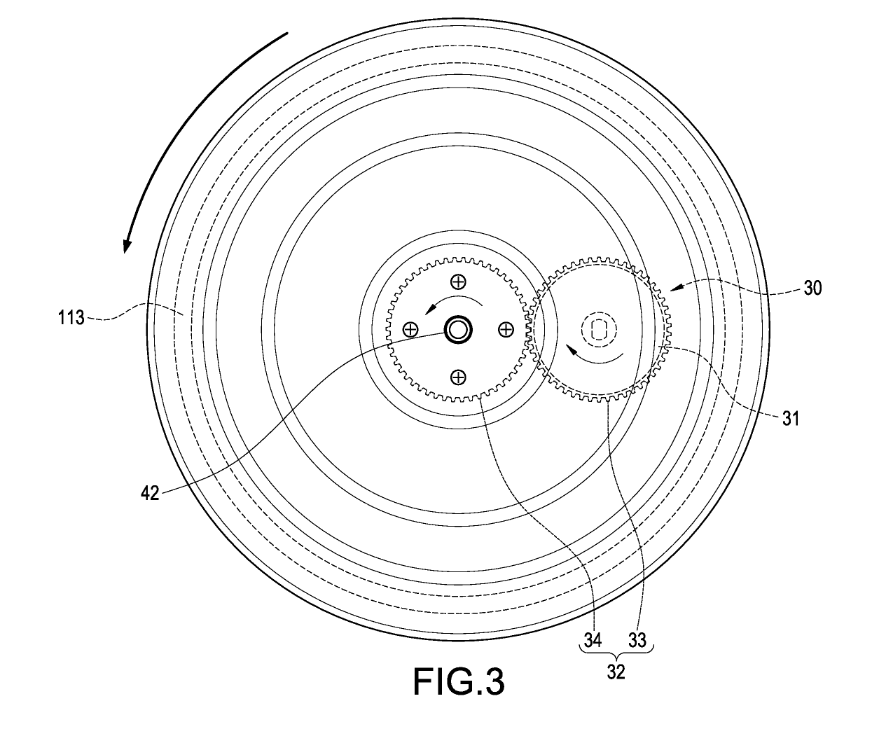

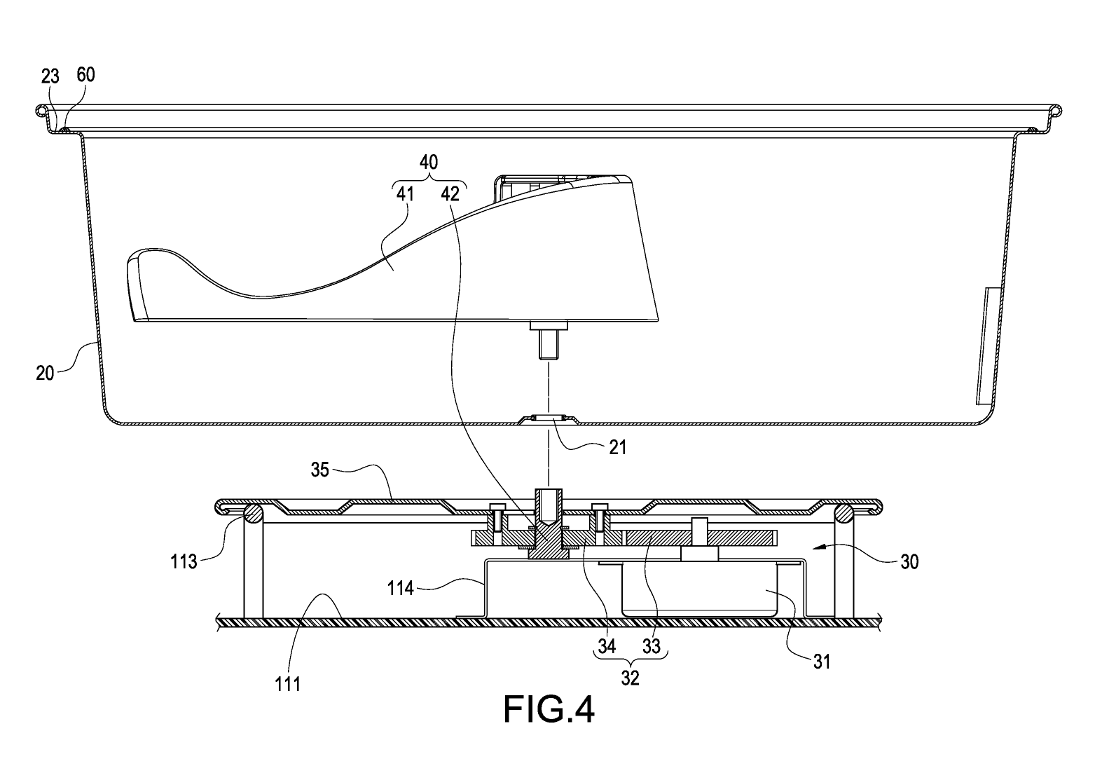

Please refer to FIGS. 1-4. The roaster of the invention includes a housing 10, a pot 20 and a driving mechanism 30.

The housing 10 includes a base 11 and a liftable arm 12. The base 11 has a bottom 111 and a wall 112 extending around the bottom 111. A supporting loop 113 and seat 114 are separately fixed on the bottom 111. One end of the liftable arm 12 is pivotally connected at one side of the base. The liftable arm 12 may be upwards opened and downwards closed. The liftable arm 12 includes an L-shaped arm 121 and a heater 122 mounted under the L-shaped arm 121.

The pot 20 is made of transparent material. The pot 20 is placed on the supporting loop 113 and surrounded by the wall 112. The pot 20 protrudes from the wall 112 so that food in the pot 20 is easy to be viewed. A through hole 21 is formed at the center of the pot 20. A blocker plate 22 is formed on the inside of the pot 20. The blocker plate 22 is formed with a bent flange 221 for preventing inside food from being spoiled by the blocker plate 22.

The driving mechanism 30 includes a motor 31, a gear set 32 and a rotary tray 35. The gear set 32 is composed of a first gear 31 and a second gear 34. The motor 31 is mounted on the seat 114. The spindle of the motor 31 is fixed to the first gear 33 and the second gear 34 is fixed to the rotary tray 35 by screws. The pot 20 is put on the rotary tray 35 and can be rotated with the rotary tray 35 driven by the motor 31 through the gear set 32.

The rotary roaster of the invention further includes a stirrer 40 composed of a blade 41 and a pin 42. The blade 41 is unrotably fixed in the pot 20. One end of the pin 42 is fixed to the seat 114 and the other end penetrates through the second gear 34, rotary tray 35 and through hole 21 and connects to the blade 41.

The rotary roaster further includes a cover 50 and a seal ring 60. The cover 50 is connected to the heater 122 in the liftable arm 12. Heat from the heater 122 is formed in the cover 50 on the pot 20. A bend portion 23 is formed on an upper edge of the pot 20. A flat portion 51 is formed on a lower edge of the cover 50. The flat portion 51 is put on the bend portion 23 and the seal ring 60 is sandwiched between the flat portion 51 and bend portion 23 for complete seal.

When the heater 122 is heating up, the pot 20 and rotary tray 35 is rotated by the motor 31 through the gear set 32 and the food in the pot 20 will be rotated with the pot 20. In the meantime, the rotating food will be stirred or mixed by the unrotatable blade 41 because of its blocking effect. Furthermore, the blocker plate 22 can cooperate with the blade 41 to sufficiently turn over the food. Thus the food in the pot 20 can be evenly and completely heated.

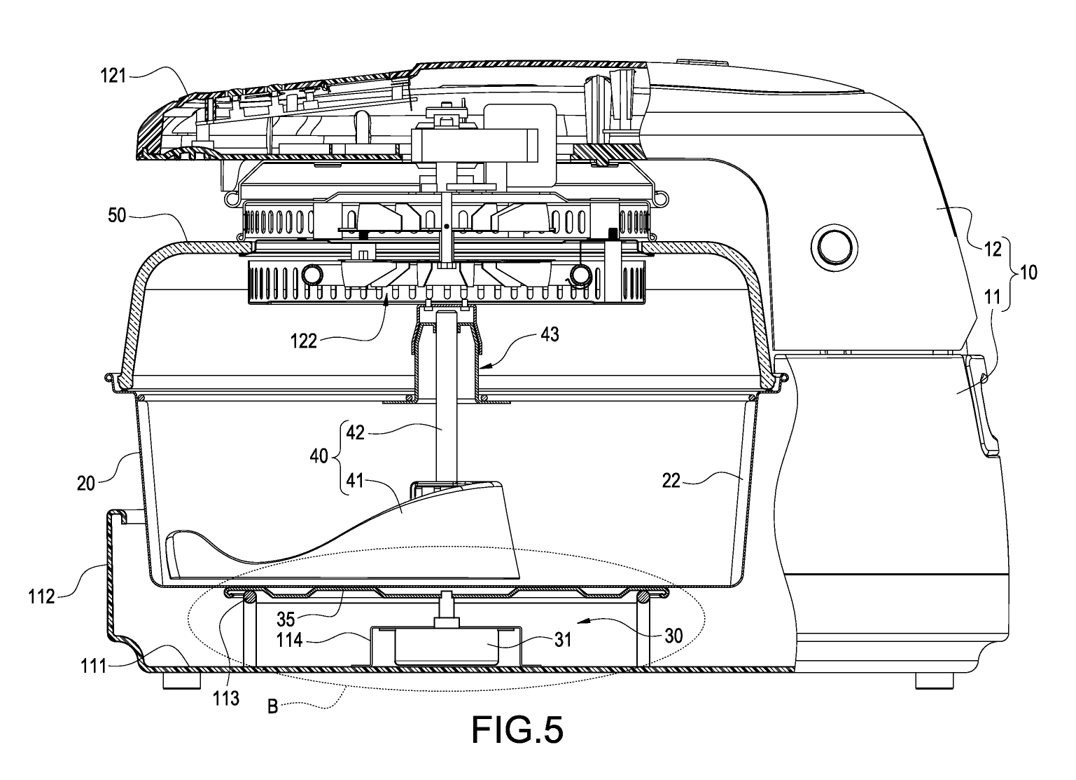

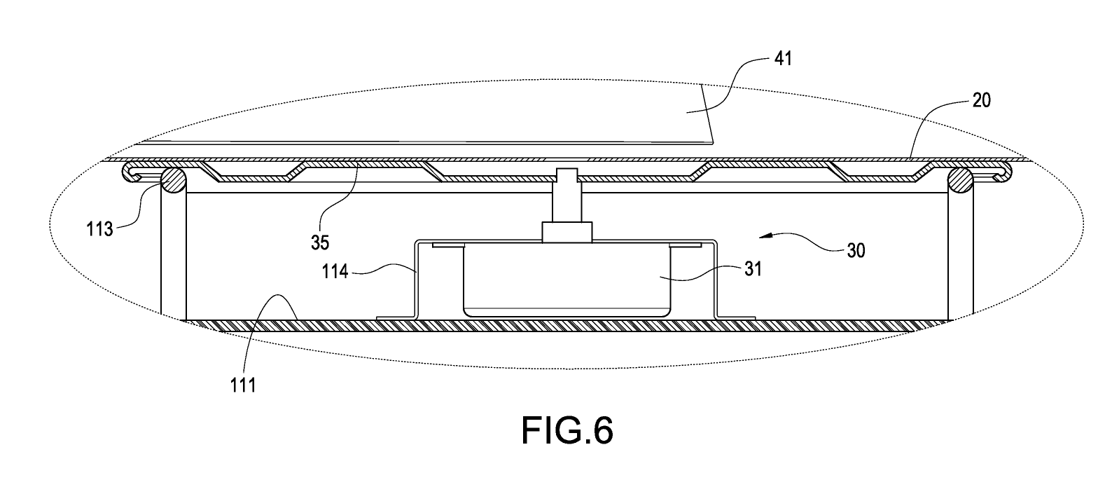

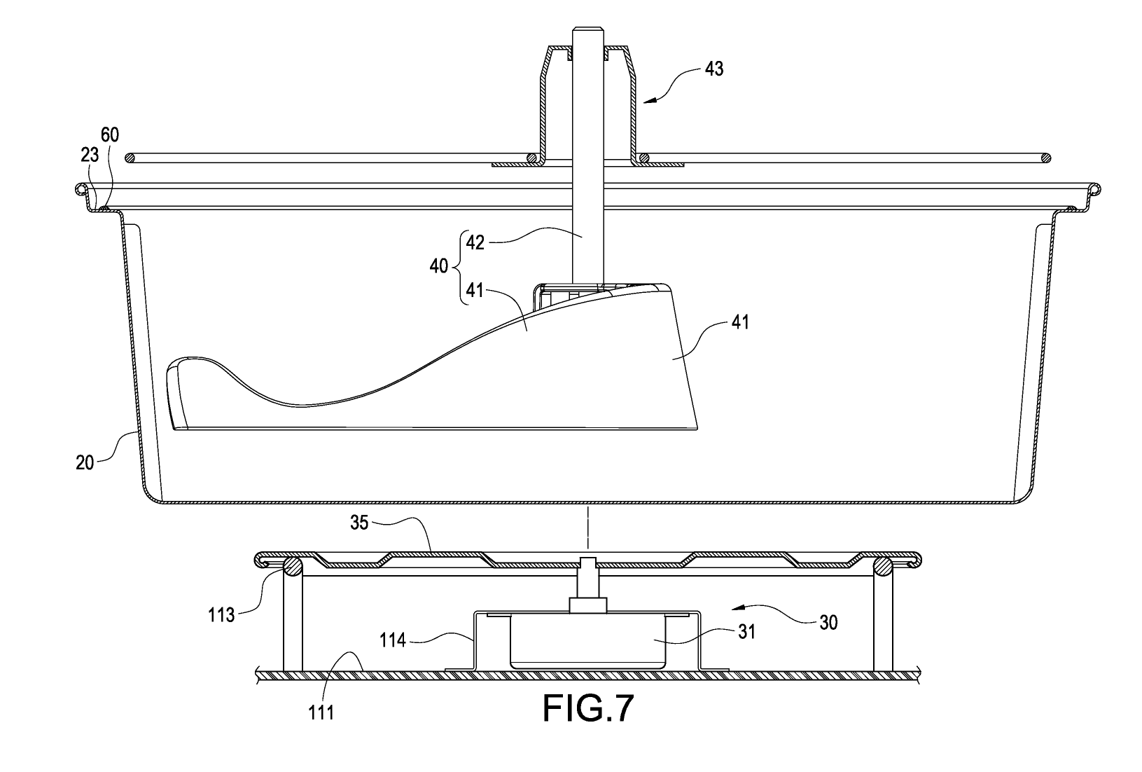

Please refer to FIGS. 5-7, which show another embodiment of the invention. In this embodiment, the pot 20 is directly driven by the motor 31. The stirrer 40 further includes a connecting rod 43. Two ends of the connecting rod 43 are fixed to the pin 42 fixed to the blade 41 and a frame of the heater 122 under the cover 50, respectively. Thus the blade 41 will not be rotated with the pot 20. This embodiment can perform the same function as the above embodiment.

It will be appreciated by persons skilled in the art that the above embodiments have been described by way of example only and not in any limitative sense, and that various alterations and modifications are possible without departure from the scope of the invention as defined by the appended claims.

What is claimed is:

1. A rotary roaster comprising:
a housing having a base;
a pot; and
a driving mechanism, disposed on the base, having a rotary tray for being placed by the pot so that the pot is rotated by the rotary tray.

2. The rotary roaster of claim 1, further comprising a stirrer, wherein the stirrer has a blade unrotably fixed in the pot.

3. The rotary roaster of claim 2, wherein the base has a bottom and a wall extending around the bottom, a supporting loop is fixed on the bottom, the pot is made of a transparent material, placed on the supporting loop and surrounded by the wall, and the pot protrudes from the wall.

4. The rotary roaster of claim 2, wherein the driving mechanism comprises a motor and a gear set, the motor is mounted on the base, the gear set comprises a first gear and a second gear engaging therewith, the first gear is fixed to a spindle of the motor, and the second gear is fixed to the rotary tray.

5. The rotary roaster of claim 4, wherein the pot is provided with a through hole, the stirrer further comprises a pin, and two ends of the pin are connected to the base and the blade with penetrating through the through hole, the second gear and the rotary tray, respectively.

6. The rotary roaster of claim 2, wherein the pot is provided with a through hole, the stirrer further comprises a pin, and two ends of the pin are connected to the base and the blade with penetrating through the through hole, respectively.

7. The rotary roaster of claim 2, wherein a blocker plate is formed on an inside of the pot, and the blocker plate is formed with a bent flange.

8. The rotary roaster of claim 2, further comprising a cover, wherein a flat portion is formed on a lower edge of the cover, a bend portion is formed on an upper edge of the pot so that the pot is covered by the cover with contact of the flat portion and the bend portion.

9. The rotary roaster of claim 8, further comprising a seal ring sandwiched between the flat portion and the bend portion.

10. The rotary roaster of claim 2, further comprising a liftable arm, wherein the liftable arm comprises an L-shaped arm pivotally connecting to the base and a heater mounted on the L-shaped arm.

11. The rotary roaster of claim 10, wherein the stirrer comprises a pin and a connecting rod fixed to the heater, and two ends of the pin c separately connect to the blade and the connecting rod.
